(19) United States
(12) Patent Application Publication
(10) Pub. No.: US 2003/0074765 A1
(43) Pub. Date: Apr. 24, 2003

(54) Tool handle

(76) Inventor: John Daniel Quimby, Weyauwega, WI (US)

Correspondence Address: Allan O. Maki, RYAN KROMHOLZ & MANION, S.C., Post Office Box 26618, Milwaukee, WI, 53226-0618, US

(21) Appl. No.: 09/983,387

(22) Filed: Oct. 22, 2001

(51) Int. Cl. A01B 1/02

(52) U.S. Cl. 16/426

(57) ABSTRACT

A handle assembly for a manually operated tool includes a first elongated handle component having a free end and a tool engaging end adapted for attachment to a tool member and an auxiliary elongated handle component having a free end and a second end adapted for attachment to the first handle component. The auxiliary handle component is provided with at least two mounts axially displaced from each other. The more distally displaced mount is adapted to pivotally attach the auxiliary handle component to the first elongated handle component.

The invention relates to a handle assembly for manually operated tools such as shovels, rakes, pitchforks, etc. More specifically the invention relates to a handle assembly which is optionally engagable with a tool member by means of either a stationary or pivotable connection.

### BACKGROUND OF THE INVENTION

Various manually operated tools such as shovels, rakes and the like entail the possibility of creating back strain and pain to the user, especially to persons who are susceptible to such pain or injuries. Heretofore various forms of auxiliary handles have been proposed with varying results. See, for example, U.S. Pat. Nos. 875,504, 2,416,414, 2,521,441, 3,082,554, 3,751,094, and 4,103,954. All of these configurations involve the use of an auxiliary handle on the main handle of a tool, usually a shovel. However all of these proposed devices have met with limited commercial success.

### SUMMARY OF THE INVENTION

It is an important object of the invention to provide an improved handle for a tool such as shovel, rake or hoe which minimizes the amount of bending over required by the user and thus substantially minimizes the back strain caused by use of the tool.

A significant aspect of the invention involves the use of a connector plate which is susceptible to deformation around a handle assembly for affixing the assembly of this invention to a conventional commercially available tool. A further important advantage of the present invention relates to the provision of such connector plate in which alternate modes of attachment can be selected by the user based on the type of tool to which the handle assembly is affixed.

In accordance with a related aspect of the invention, a coupling connector is provided which is deformable and capable of being bent around the handle of any manual tool. Generally the connection is attached in the vicinity of the neck where the tool and handle meet. Further, in accordance with this aspect, a conventional mechanical fastener such as a bolt or rivet can be used to couple the handle pivotably to the main handle. The optional pivotable connection of the handle to the tool provides a pivoting motion which facilitates many tasks such as shoveling of dirt or snow, use of a pitchfork or use of a garden fork, all of which require a swinging motion. In accordance with the advantages provided by the present invention the tool user is allowed to remain standing or upright in a correct ergonomic alignment.

In accordance with a further related aspect of the invention, the coupling connector enables the attachment of the auxiliary handle of this invention to the main tool handle, alternatively, by means of one or a pair of fasteners such as bolts. Such optional attachment by at least two fasteners attaches the auxiliary handle in the fixed mode and prevents pivoting between the handle and the tool. Fixed attachment is desirable in application of the invention to tools requiring a pulling action, such as rakes, hoes, concrete floats, etc. In each case, the user's back is enabled to remain in an upright ergonomic alignment which minimizes back strain.

Briefly, the invention provides a handle assembly for a manually operated tool which includes a first elongated handle component having a free end and a tool engaging end adapted for attachment to a tool member and an auxiliary elongated handle component having a free end and a second end adapted for attachment to the first handle component. The auxiliary handle component is provided with at least two mounts axially displaced from each other. The more distally displaced mount is adapted to pivotally attach auxiliary handle component to the first elongated handle component.

Further objects and advantages of the invention will be apparent from the following detailed description, the accompanying drawings and the attached claims.

### DESCRIPTION OF THE DRAWINGS

FIG. 1 is a perspective view of a shovel with an auxiliary handle attached thereto and with an alternate position thereof shown by phantom lines;

FIG. 2 is a a perspective view of a mounting bracket useful in the practice of the invention;

FIG. 3 is a side elevational view of another tool with an auxiliary handle affixed thereto in accordance with the invention; and,

FIG. 4 is a side elevational view of a shovel in accordance with a further embodiment of the invention.

### DETAILED DESCRIPTION

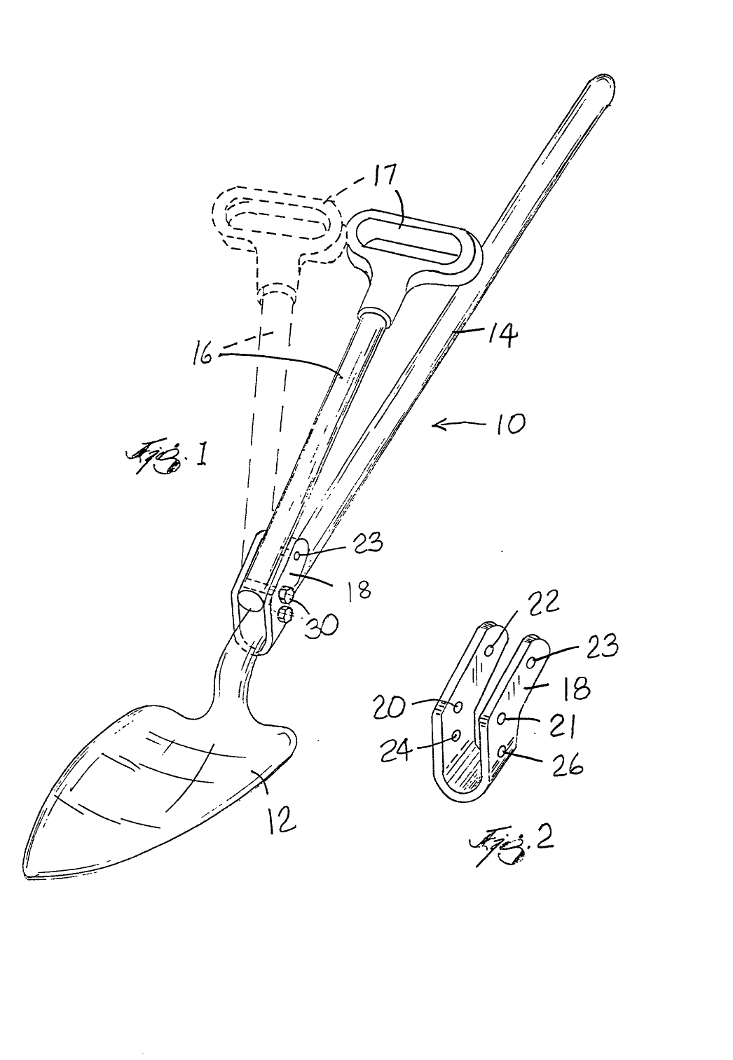

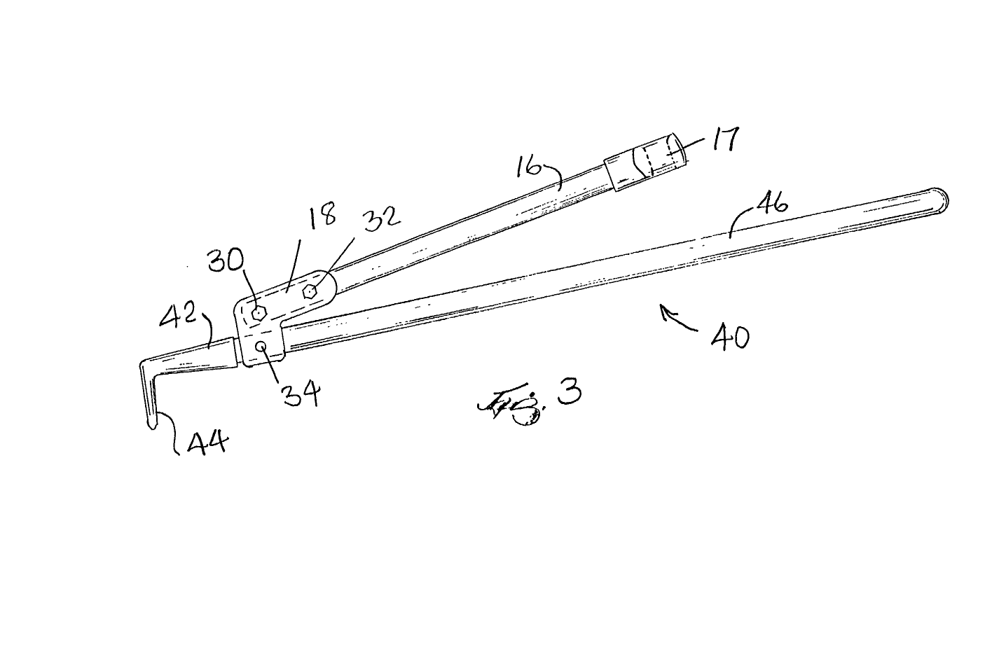

Referring more particularly to the drawings there is seen in FIG. 1 a shovel 10 of conventional design having a blade 12 and a handle 14. In accordance with the present invention an auxiliary handle 16 having a grasping handle 17 at its free end is pivotally attached to a bracket 18. As seen more clearly in FIG. 2 bracket 18 has a pair of openings 20 and 21 for pivotally attaching handle 16 to the shovel 10 using a bolt 30. Bolt 30 may be replaced by any other elongated mechanical fastener such as a pin or rivet or a pair of wood screws, if desired.

A second pair of aligned openings 22 and 23 is provided in the bracket 18 for optionally securing the handle 16 in a fixed position. Also optionally provided are openings 24 and 26 which can, if desired, be used to secure the handle 16 in a fixed axial and rotationally position on the handle 14.

While bracket 18 is illustrated in a U-shaped configuration, it can be provided in the form of a flat member which can be bent to shape when installed by the user on the handle 14. Also if fixation of the rotational position of the auxiliary handle 16 is considered unimportant, the holes 24 and 26 can be omitted.

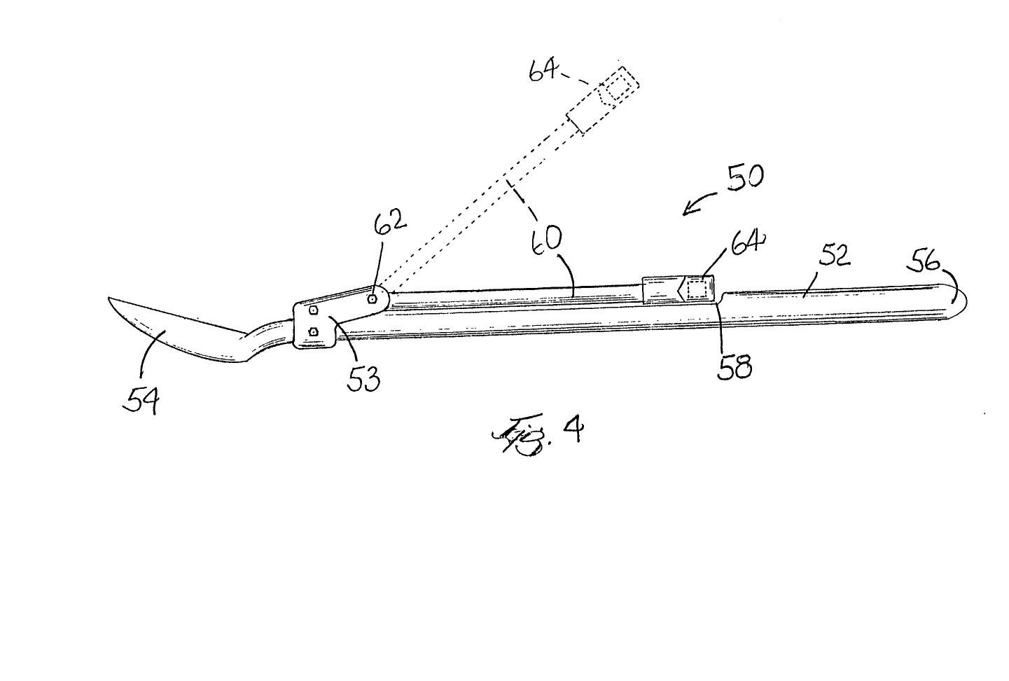

Referring to FIG. 3 there is shown a further illustration of the use of the auxiliary handle 16 of this invention. In the embodiment shown in FIG. 3, a conventional hoe 40 is illustrated. Hoe 40 includes a metal shank 42 which supports which supports a hoe blade 44 at generally right angles to a handle 46. As seen, the position of handle 16 can be fixed by the use of a screw, nail etc. inserted through the opening 34. Also two bolts 30 and 32 are installed through the bracket 18 and the fixed end of handle 16. In general it is desired to attach the handle 16 in a fixed position when using the handle on a tool such as a rake, hoe, concrete float, pick ax, etc. which requires a pulling action. The use of the auxiliary handle 16 of this invention enables the user to remain in a more upright position enabling the retention of proper posture. Thus back strain caused by use of the tool is substantially minimized.

In contrast, the pivotal attachment of the auxiliary handle shown in FIG. 1 is desirable in connection with tool usages which require a swinging motion. In such cases use of the pivoting auxiliary handle allows the body to remain in a correct upright ergonomic alignment to minimize back strain. Such applications include snow shoveling, dirt shoveling, use of a garden or pitchfork, etc.

The handles of this invention can be constructed of wood, plastic, or if desired, metal, especially a lightweight metal such as aluminum.

A still further embodiment of the invention is shown in FIG. 4. In connection with this embodiment a shovel 50 is provided with a handle 52 attached to a blade 54 having a free end 56. As seen, handle 52 has a cut away or indented portion 58. The auxiliary handle 60 is pivotally attached by means of a mechanical fastener 62 to the shank 53 of the shovel 50. Handle 60 is provided with a gripping end 64, optionally, the handle 52 can be provided with an aperture therethrough to receive the fastener 62, thus eliminating the need for bracket 53.

It is contemplated that the auxiliary handle 60 of FIG. 4 would be attached to the shovel 50 at the time of manufacture. Since the handle 60 fits into the recess 58 in the handle 52 an economy of space is provided, facilitating the storage of the shovel 50 when not in use and providing a configuration which is suitable for display at a retail point of sale.

The foregoing is considered as illustrative only of the principles of the invention. Furthermore, since numerous modifications and changes will readily occur to those skilled in the art, it is not desired to limit the invention to the exact construction and operation shown and described. While the preferred embodiment has been described, the details may be changed without departing from the invention, which is defined by the claims.

What is claimed is:

1. A handle assembly for a manually operated tool having a first elongated handle component which includes a free end and a tool engaging end adapted for attachment to a tool member comprising
a second elongated handle component having a free end and a second end adapted for attachment to said first handle component,
said second handle component being provided with at least two mounts axially displaced from each other thereon, said mounts including a first more distally displaced mount adapted to pivotally attach said second handle component to said first handle component.

2. A handle assembly according to claim 1 wherein a second mount is positioned proximal to said first mount, attachment of both of said first and second mounts providing a non-pivoting attachment of said handle assembly to said tool member.

3. A handle assembly according to claim 1 wherein said mounts comprise openings through a metal mounting bracket which is adapted for attachment to said first elongated handle component.

4. A shovel comprising
a blade,
a handle assembly attached to said blade comprising a first elongated handle component provided with a free end and an opposite end attached to said blade,
a second elongated handle component having a free end and a second end pivotally attached to said first handle component,
said first handle component being provided with an elongated recess into which said second handle component is nestingly received.
